(19) United States
(12) Patent Application Publication
(10) Pub. No.: US 2017/0189805 A1
(43) Pub. Date: Jul. 6, 2017

(54) METHOD AND SYSTEM FOR PROCESSING MODULE MODULIZATION OF SERVER-SIDE LOGIC

(71) Applicants: NHN Entertainment Corporation, Seongnam-si (KR); NHN Studio629 Corporation, Seongnam-si (KR)

(72) Inventor: Chuljae LIM, Seongnam-si (KR)

(21) Appl. No.: 15/392,670

(22) Filed: Dec. 28, 2016

(30) Foreign Application Priority Data
Dec. 31, 2015 (KR) 10-2015-0191311

(51) Int. Cl. A63F 13/35; H04L 12/24; H04L 29/06

(52) U.S. Cl. CPC A63F 13/35; H04L 67/42; H04L 41/20

(57) ABSTRACT

Provided is a module processing method and system for modulization of a server-side logic. A server may manage and process server-side modules that are developed by a server-side developer and a client-side developer, respectively, and may provide a service to a client to achieve the specialization of server development. A server may receive, store, and manage a first server module file corresponding to a server program and a second server module file corresponding to a client program; execute a server operation for a service using a program code comprised in the first server module file; and process a service logic corresponding to the service provided to a client using a program code comprised in the second server module file, the client accessing the server using a client program.

### CROSS-REFERENCE TO RELATED APPLICATION

This application claims priority from and the benefit of Korean Patent Application No. 10-2015-0191311, filed on Dec. 31, 2015, which is hereby incorporated by reference for all purposes as if fully set forth herein.

### BACKGROUND

Field

Exemplary embodiments relate to a module processing method and system for modulization of a server-side logic.

Discussion of the Background

In recent related arts, an entity that develops a service and an entity that operates a server are typically separate in a server-client environment. For example, a server that provides a service operates through a source, for example, a program code, developed by an entity that operates a server. The source may be created as a single module file. Server program developers of the entity that operates the server may develop modules for the server as a single module file. Developers of an entity that develops a service may develop a client program that may be installed and executed on a client, and may distribute the developed client program to clients. Here, the clients may access the server using the client program, and the server may provide the service to the clients accessing the server using a module developed for the server.

FIG. 1 is a diagram illustrating an example of a server module file according to the related art.

In the related art, a server 100 operates through a single file, such as ServerProgram.exe 110, which includes program code, such as a database (DB) access source 111, a service logic source 112, an access management source 113, and an external module management source 114. That is, the server 100 according to the related art provides a service to a client 120 on which a client program 121 is installed and executed under control of a program code included in the single file. Here, the DB access source 111 may include a processing code for writing or reading data from a database associated with the service, and the service logic source 112 may include a processing code for a service logic to be provided, such as a game logic. Also, the access management source 113 may include a processing code for managing access of the client 120, and the external module management source 114 may include a processing code for managing various external modules.

Various external modules, for example, a dynamic linking library (DLL) file, may be used based on a service. However, the modules may be used for general operations. Server-side operations to be developed for providing the service may be created as a single module file and thereby used.

Accordingly, the complexity of a code included in a module file to be developed increases, correcting the code becomes more difficult, and a module file needs to be built again every time a code changes.

In addition, since a server-side service logic may be included in a module file, a server program developer needs to sufficiently learn knowledge about the service to be provided from a client program developer. For example, if a card game service is provided, a server program developer that operates a server also needs to be aware of rules of the card game service and to develop a module file by including a server-side service logic about the card game service in the module file.

If different developers develop the same object on a program, the developers may have different understandings of a concept on the same object. Thus, the same object may be developed in different manners or may be developed to operate differently. In many cases, an understanding of a service developer and an understanding of a server-side developer about the same service may greatly differ from each other. Thus, coordinating the difference may require a long time and be costly. Since each of the service developer and the server-side developer develops the same operation, for example, authentication, hacking prevention logic, etc., development may require additional cost and incompatibility may arise.

FIG. 2 illustrates an example of program code used to create a card using different schemes in a card game according to the related art. All of a first program code 210 and a second program code 220 are program codes to generate cards of a trump card game. While a card number starts from ‘1’ in the first program code 210, a card number starts from ‘0’ in the second program code 220. Thus, the first program code 210 and the second program code 220 are incompatible with each other.

If a server-side program code and a client-side program differ from each other as in the first program code 210 and the second program code 220 of FIG. 2, ‘1’ needs to be added or subtracted when data is exchanged between a server side and a client side. Accordingly, occurrence of a program code error or a logic error may increase.

The above information disclosed in this Background section is only for enhancement of understanding of the background of the inventive concept, and, therefore, it may contain information that does not form the prior art that is already known in this country to a person of ordinary skill in the art.

### SUMMARY OF THE INVENTION

One or more exemplary embodiments provide a module processing method and system of a server that provides instruction to develop a program code closely related to a service, such as a server-side service logic, among server-side program codes, thereby providing a service through modularized server-side program codes.

Additional features will be set forth in the description which follows, and in part will be apparent from the description, or may be learned by practice of the inventive concept.

Exemplary embodiments disclose a module processing method of a server configured to provide a service in a server-client environment, the method including receiving, storing, and managing, at the server, a first server module file corresponding to a server program; receiving, storing, and managing, at the server, a second server module file corresponding to a client program; executing, at the server, a server operation for the service using a program code comprised in the first server module file; and processing, at the server, a service logic corresponding to the service provided to a client using a program code comprised in the second server module file, the client accessing the server using a client program.

Exemplary embodiments also disclose a module processing system of a server configured to provide a service in a server-client environment, the module processing system including at least one processor configured to execute non-transitory computer-readable instructions. The at least one processor includes a file management controller configured to control the server to receive, store, and manage a first server module file corresponding to a server program, and to control the server to receive, store, and manage and a second server module file corresponding to a client program; and a logic processor configured to execute a server operation for the service using a program code comprised in the first server module file, and to process a service logic corresponding to the service provided to a client using a program code comprised in the second server module file, the client accessing the server using a client program code.

It is to be understood that both the foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the invention and are incorporated in and constitute a part of this specification, illustrate exemplary embodiments of the inventive concept, and together with the description serve to explain the principles of the inventive concept.

FIG. 1 illustrates an example of a server module file according to the related art.

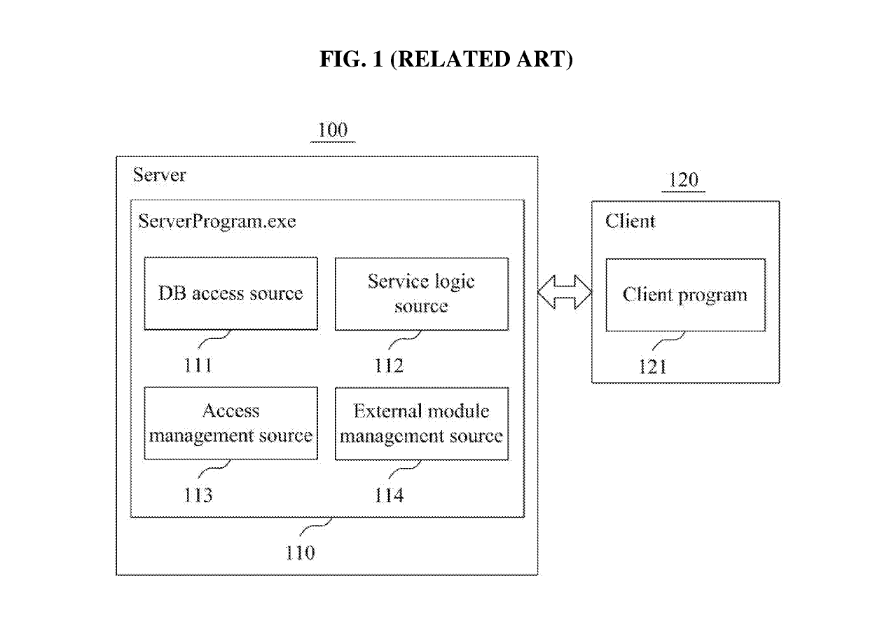

FIG. 2 illustrates an example of program codes used to create a card using different schemes in a card game according to the related art.

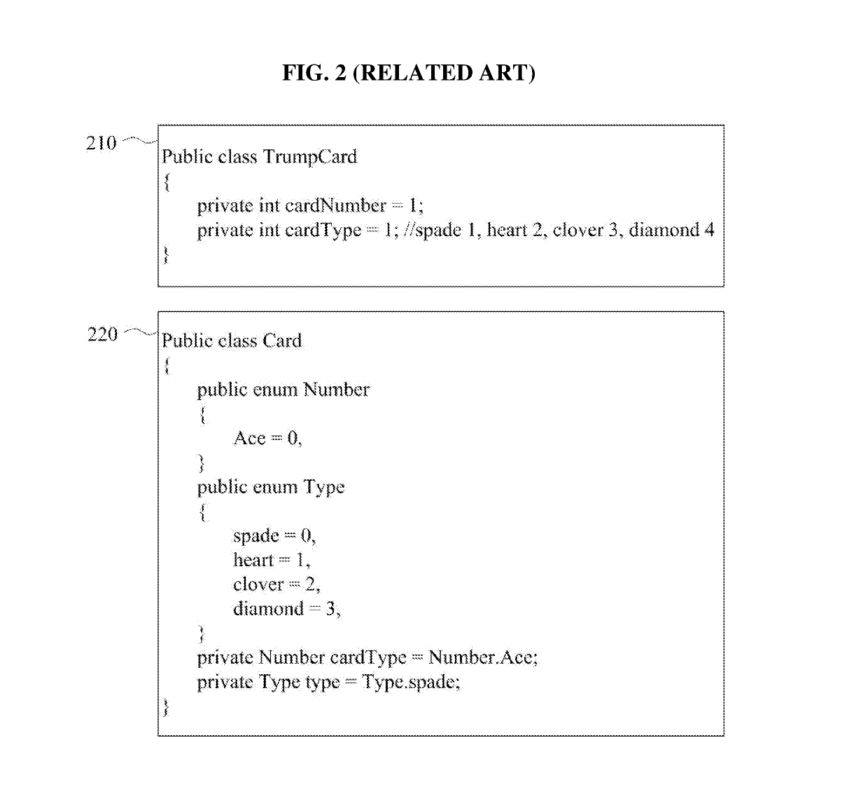

FIG. 3 illustrates an example of a network environment according to an exemplary embodiment.

FIG. 4 illustrates a configuration of an electronic device and a server according to an exemplary embodiment.

FIG. 5 illustrates an example of a processor of a server according to an exemplary embodiment.

FIG. 6 is a flowchart illustrating an example of a module processing method performed at a server according to an exemplary embodiment.

FIG. 7 illustrates an example of server-side modules according to an exemplary embodiment.

FIG. 8 illustrates an object inheritance according to an exemplary embodiment.

### DETAILED DESCRIPTION OF THE ILLUSTRATED EMBODIMENTS

One or more exemplary embodiments will be described in detail with reference to the accompanying drawings. Exemplary embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some exemplary embodiments. Unless otherwise noted, like reference characters denote like elements throughout the attached drawings and written description, and thus descriptions will not be repeated.

In the drawings, the size and relative sizes of regions and components may be exaggerated for clarity. Like numerals denote like elements.

When an element is referred to as being “on,” “connected to,” or “positioned on” another element or layer, it may be directly on, connected to, or positioned on the other element or intervening elements may be present. When, however, an element is referred to as being “directly on,” “directly connected to,” or “directly positioned on” another element, there are no intervening elements present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various elements, components, regions, and/or sections, these elements, components, regions, and/or sections should not be limited by these terms. These terms are used to distinguish one element, component, region, and/or section from another element, component, region, and/or section. Thus, a first element, component, region, and/or section discussed below could be termed a second element, component, region, and/or section without departing from the teachings of the present disclosure.

Spatially relative terms, such as “beneath,” “below,” “lower,” “above,” “upper,” “left,” “right,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing exemplary embodiments only and is not intended to be limiting. As used herein, the singular forms “a”, “an”, and “the” are intended to include the plural forms as well, unless the context clearly indicates otherwise. Moreover the terms “comprises,” “comprising,” “have,” “having,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

Exemplary embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Units and/or devices according to one or more exemplary embodiments may be implemented using hardware, software, and/or a combination thereof. For example, hardware devices may be implemented using processing circuity such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions (i.e., code) in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

According to one or more exemplary embodiments, computer processing devices may be described as including various functional units that perform various operations and/or functions to increase the clarity of the description. However, computer processing devices are not intended to be limited to these functional units. For example, in one or more exemplary embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more exemplary embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the exemplary embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the exemplary embodiments, or they may be known devices that are altered and/or modified for the purposes of exemplary embodiments.

A hardware device, such as a computer processing device, may run an operating system (OS) and one or more software applications that run on the OS. The computer processing device also may access, store, manipulate, process, and create data in response to execution of the software. For simplicity, one or more exemplary embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of exemplary embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents

Hereinafter, exemplary embodiments will be described with reference to the accompanying drawings.

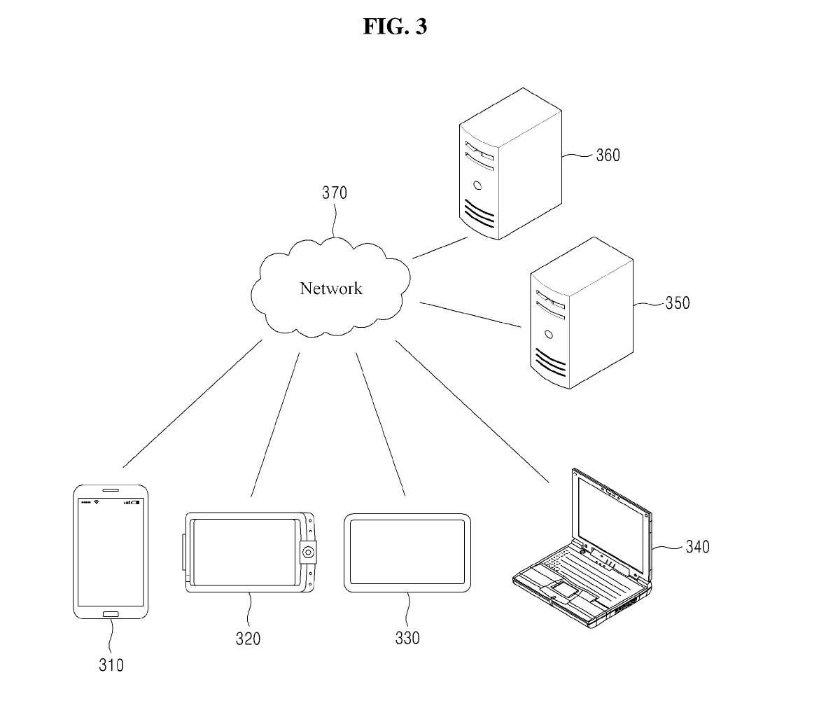

FIG. 3 illustrates an example of a network environment according to an exemplary embodiment. Referring to FIG. 3, the network environment includes a plurality of electronic devices 310, 320, 330, and 340, a plurality of servers 350 and 360, and a network 370. FIG. 3 is provided as an example only and thus, the number of electronic devices and/or the number of servers are not limited thereto.

Each of the plurality of electronic devices 310, 320, 330, and 340 may be a fixed terminal or a mobile terminal that may be a computer device. For example, the plurality of electronic devices 310, 320, 330, and 340 may be a smartphone, a mobile phone, a navigation device, a computer, a laptop computer, a digital broadcasting terminal, a personal digital assistant (PDA), a portable multimedia player (PMP), a tablet PC, etc. For example, the electronic device 310 may communicate with other electronic devices 320, 330, and/or 340 and/or the servers 350 and/or 360 over the network 370 including a wired communication or a wireless communication.

The communication scheme is not particularly limited, and may include a communication method that uses a wireless near-field communication between devices as well as a communication method using a communication network, for example, a mobile communication network, the wired Internet, the wireless Internet, a broadcasting network, etc., which may be included in the network 370. For example, the network 370 may include at least one of network topologies that include networks, for example, a personal area network (PAN), a local area network (LAN), a campus area network (CAN), a metropolitan area network (MAN), a wide area network (WAN), a broadband network (BBN), etc. Also, the network 370 may include at least one of network topologies that include a bus network, a star network, a ring network, a mesh network, a star-bus network, a tree or hierarchical network, etc. However, it is only an example and the exemplary embodiments are not limited thereto.

Each of the servers 350 and 360 may be a computer device or a plurality of computer devices that provides instructions, codes, files, contents, services, etc., through communication with the plurality of electronic devices 310, 320, 330, and/or 340 over the network 370.

For example, the server 360 may provide a file for installing an application to the electronic device 310 connected through the network 370. In this case, the electronic device 310 may install the application using the file provided from the server 360. Also, the server 360 may access the server 350 under control of at least one program, for example, a browser or the installed application, and an operating system (OS) included in the electronic device 310, and may use a service or content provided from the server 350. For example, in response to a service request message transmitted from the electronic device 310 to the server 350 over the network 370 under control of the application, the server 350 may transmit a code corresponding to the service request message to the electronic device 310, and the electronic device 310 may provide content to the user by configuring and displaying a screen corresponding to the code under control of the application. For example, the server 350 may set a communication session for a messaging service, and may route a message transmission and reception between the plurality of electronic devices 310, 320, 330, and/or 340 through the set communication session. For example, the server 350 may relay a video call between the plurality of electronic devices 310, 320, 330, and/or 340. For example, the server 350 may also provide a game service to the plurality of electronic devices 310, 320, 330, and/or 340.

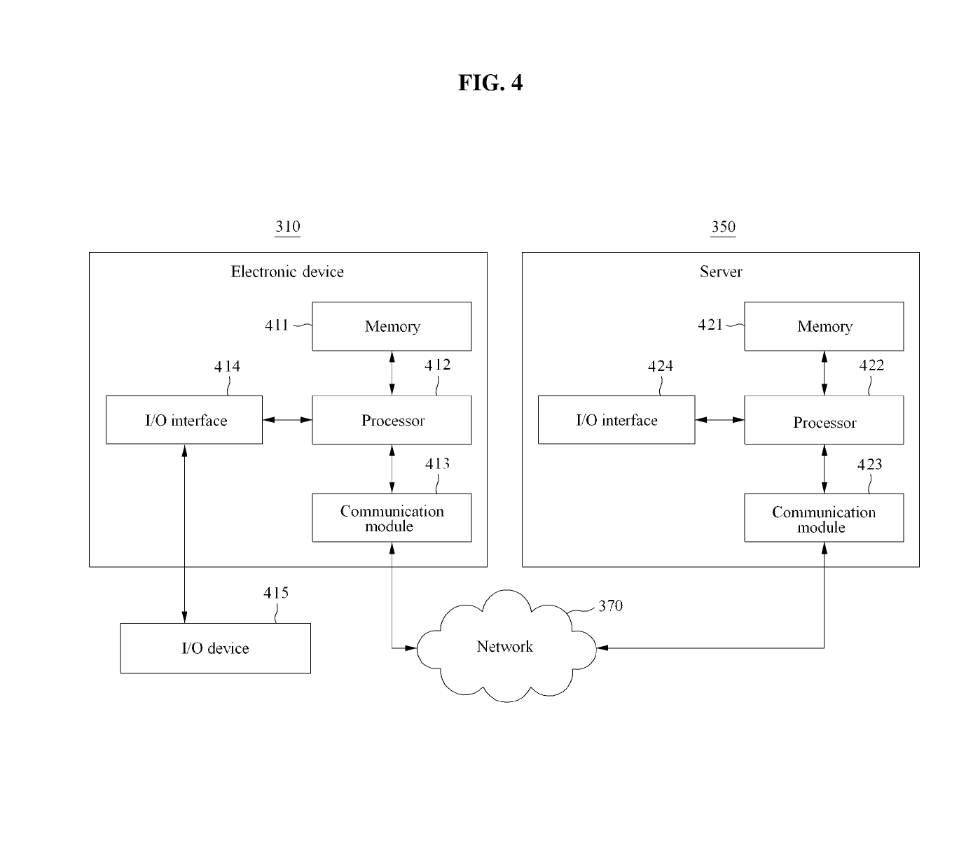

FIG. 4 illustrates an example of an electronic device and a server according to an exemplary embodiment. FIG. 4 illustrates an exemplary configuration including a single electronic device 310 and illustrates an exemplary configuration including the single server 350. However, exemplary embodiments are not limited thereto. For example, other electronic devices 320, 330, and/or 340, or the server 360 may have same or similar configurations.

Referring to FIG. 4, the electronic device 310 may include a memory 411, a processor 412, a communication module 413, and an input/output (I/O) interface 414, and the server 350 may include a memory 421, a processor 422, a communication module 423, and an I/O interface 424. The memory 411 and 421 may include a permanent mass storage device, such as random access memory (RAM), read only memory (ROM), a disk drive, etc., as a computer-readable storage medium. Also, an OS and at least one program code, for example, a code for a browser or an application for video call installed and executed on the electronic device 310, may be stored in the memory 411 and 421. Such software may be loaded from another computer-readable storage medium separate from the memory 411 and 421 using a drive mechanism. The other computer-readable storage medium may include, for example, a floppy drive, a disk, a tape, a DVD/CD-ROM drive, a memory card, etc. According to exemplary embodiments, software may be loaded to the memory 411 and 421 through the communication module 413 and 423, instead of, or in addition to, the computer-readable storage medium. For example, at least one program code may be loaded to the memory 411 and 421 based on a program, for example, the application, installed by files provided over the network 370 from developers or a file distribution system, for example, the server 360, which provides an installation file of the application.

The processor 412 and 422 may be configured to process computer-readable instructions, for example, the aforementioned at least one program code, of a computer program by performing basic arithmetic operations, logic operations, and I/O operations. The computer-readable instructions may be provided from the memory 411 and 421 and/or the communication module 413 and 423 to the processor 412 and 422. For example, the processor 412 and 422 may be configured to execute received instructions in response to the program code stored in the storage device, such as the memory 411 and 421.

The communication module 413 and 423 may provide communication between the electronic device 310 and the server 350 over the network 370, and may provide communication with another electronic device, for example, the electronic device 320 or another server, for example, the server 360. For example, the processor 412 of the electronic device 310 may transfer a request, for example, a request for a video call service, created based on a program code stored in the storage device such as the memory 411, to the server 350 over the network 370 under control of the communication module 413. Inversely, a control signal, an instruction, content, a file, etc., provided under control of the processor 422 of the server 350 may be received by the electronic device 110 through the communication module 413 of the electronic device 310 by going through the communication module 423 and the network 370. For example, a control signal, an instruction, etc., of the server 350 received through the communication module 413 may be transferred to the processor 412 or the memory 411, and content, a file, etc., may be stored in a storage medium further includable in the electronic device 310.

The I/O interface 414 and 424 may be an interface device with an I/O device 415. For example, an input device may include a keyboard, a mouse, etc., and an output device may include a device, such as a display for displaying a communication session of an application. The I/O interface 414 may also be an interface device including an apparatus having both the input function and an output function integrated, such as a touch screen. In detail, when processing instructions of the computer program are loaded to the memory 411, the processor 412 of the electronic device 310 may display a service screen using data provided from the server 350 or the electronic device 320, or may display content on a display through the I/O interface 414.

According to exemplary embodiments, the electronic device 310 and the server 350 may include a greater or smaller number of elements than the number of elements shown in FIG. 4, and exemplary embodiment are not limited thereto. For example, the electronic device 310 may include at least a portion of the I/O device 415, or may further include, for example, a transceiver, a global positioning system (GPS) module, a camera, a variety of sensors, a database, etc. For example, if the electronic device 310 is a smartphone, the electronic device 310 may further include, for example, an acceleration sensor or a gyro sensor, a camera, various types of buttons or a button using a touch panel, an I/O port, etc., which may be included in a smart phone.

In the exemplary embodiments, the server 350 may be a system apparatus that provides a service to communication terminals, for example, the electronic device 310 and the electronic device 320, connected over the network 370.

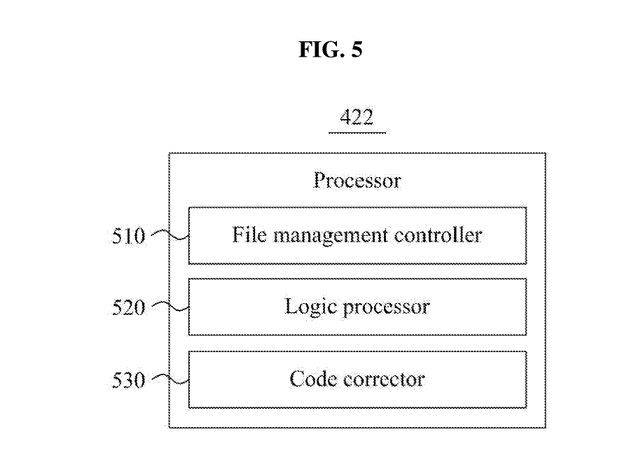

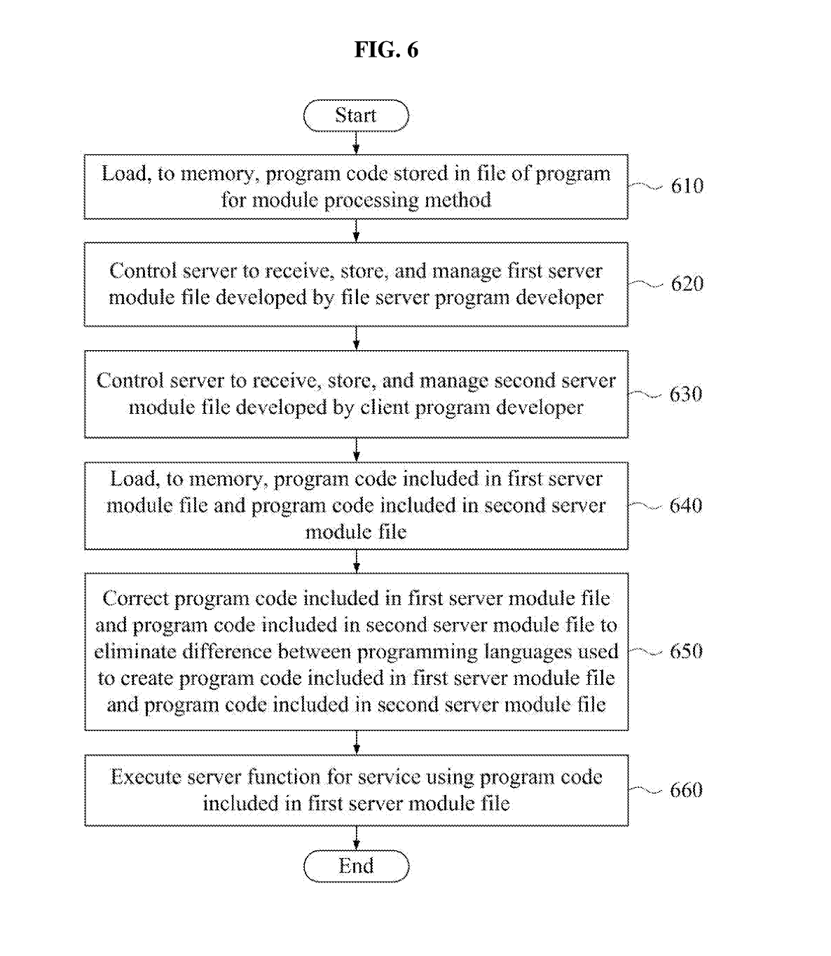

FIG. 5 illustrates an example a processor of a server according to an exemplary embodiment, and FIG. 6 is a flowchart illustrating an example of a module processing method performed at a server according to an exemplary embodiment.

The server 350 may be, for example, a game server that provides a game service and a system apparatus that provides a game service. Referring to FIG. 5, the processor 422 of the server 350 may include a file management controller 510, a logic processor 520, and a code corrector 530. The code corrector 530 may be selectively included in the processor 422 and thereby used. The processor 422 and the file management controller 510, the logic processor 520, and the code corrector 530 in the processor 422 may control the server 350 to perform operations 610 through 660 as illustrated in the module processing method of FIG. 6. The processor 422 and the file management controller 510, the logic processor 520, and the code corrector 530 of the processor 422 may execute instructions according to at least one program code and a code of the OS included in the memory 421. Here, the file management controller 510, the logic processor 520, and the code corrector 530 of the processor 422 may be used to perform different operations at the processor 422. For example, the logic processor 520 may be used so that the processor 422 may process a service logic in response to the aforementioned instruction.

In step 610, the processor 422 may load, to the memory 421, a program code stored in a file of a program for the module processing method. For example, the program may be a program installed on the server 350 to manage files used to provide a service and to load program codes included in the files to the memory 421. In response to an execution of the program installed on the server 350, the processor 422 may load a program code from a file of the program to the memory 421.

In step 620, the file management controller 510 may control the server 350 to receive, store, and manage a first server module file developed by a server program developer. The first server module file may include a module to manage a connection to a database constructed for the service and a module to manage an access of a client. The first server module file may include, for example, a module to manage an external module. The server program developer may develop and provide general server-side operations.

In step 630, the file management controller 510 may control the server 350 to receive, store, and manage a second server module file developed by a client program developer. The second server module file may include a module to control the server 350 to process a service logic for providing a service to a client. For example, a program code, such as the service logic, for controlling the server 350 to process characteristic operations with respect to a service to be provided may be developed by the client program developer and provided to the server 350.

A basic common object module created using an objective-oriented programming language for developing each server module file may be provided to each of the server program developer and the client program developer. For example, each of the first server module file and the second server module file may include a program code that is developed based on an object inheritance for the basic common object module. Accordingly, the common portion of the first server module file and the second server module file may not need to be separately developed which may prevent or reduce a misunderstanding or a communication error. In addition, due to the common portion, the amount of the entire code for the first server module file and the second server module file may be reduced.

In operation 640, the processor 422 may load, to the memory 421, the program code included in the first server module file and the program code included in the second server module file.

In step 650, the code corrector 530 may correct the program code included in the first server module file and the program code included in the second server module file to eliminate a difference between programming languages used to create the program code included in the first server module file and the program code included in the second server module file. The program code included in the first server module file and the program code included in the second server module file may be created using different programming languages. For example, the program code included in the first server module file may be created using a programming language, such as C++ or C, for performance of the server 350. The program code included in the second server module file may be created using a programming language, such as C# of unity for convenient creation. For example, “List” used in C# and “list” used in C++ have different meanings. Difference according to a programming language may be for example:
List(C#)=vecter(C++)
ArrayList(C#)=Array(C++)
LinkedList(C#)=list(C++)

“List” used in C# corresponds to “vector” used in C++. “ArrayList” used in C# corresponds to “Array” used in C++. “LinkedList” used in C# corresponds to “list” used in C++. Accordingly, depending on a programming language used as above, an error may occur in data transmitted and received between the server 350 and a client. To eliminate a difference between different programming languages, the code corrector 530 may correct the program code included in the first server module file or the program code included in the second server module file. Step 650 may be selectively included in the module processing method.

In step 660, the logic processor 520 may execute a server operation for the service using the program code included in the first server module file. In this instance, the logic processor 520 may process the service logic for providing the service to the client accessed through the server operation, using the program code included in the second server module file. For example, the service may include a game service. For example, the service logic may be a logic for controlling a game provided through the game service to the client based on a rule of the game, and may be controlled at the server 350 based on the program code included in the second server module file.

The client may include an electronic device, for example, the electronic device 310, in which a client program created by the client program developer is installed and executed, and may access the server 350 over a network under control of the client program.

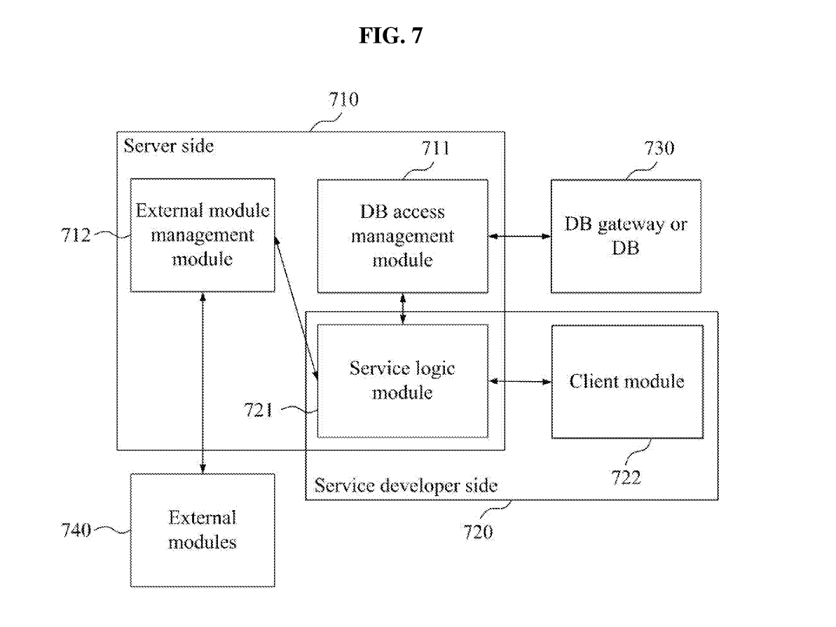

FIG. 7 illustrates an example of server-side modules according to an exemplary embodiment. Modules, such as a database access management module 711 and an external module management module 712, for a server 350 may be developed by a server program developer and included on a server side 710. The server side 710 may further include an access management module configured to manage an access of a client and the like.

A service logic is a single module file in the related art, whereas a server logic according to exemplary embodiments may be developed by a service developer side 720 and included as a separate service logic module 721. As described above, a program code for the service logic may be received as a separate module through a second server module file developed by a client program developer. A client module 722 may include an application that is installed and executed on an electronic device.

For example, in response to an access of the electronic device 110 to the server 350 through the client module 722, the server 350 may provide a service to the electronic device 110 through the service logic module 721.

For example, the database access management module 711 may write or read data used for providing the service using a database gateway or a database 730. The external module management module 712 may be used to manage external modules 740. The service logic module 721 may be managed by the external module management module 712 as a single external module.

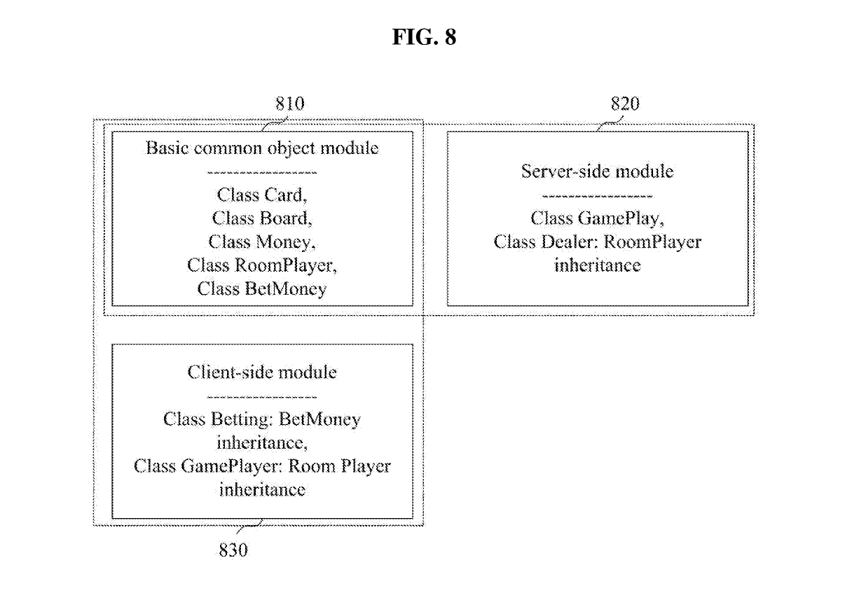

FIG. 8 illustrates an object inheritance according to exemplary embodiments. As described above, a basic common object module 810 may be created using an objective-oriented programming language. The basic common object module 810 may be provided to each of a server program developer and a client program developer. Each of the server program developer and the client program developer may develop a program code based on an object inheritance with respect to the provided basic common object module 810.

Many of classes created at a server-side module 820 may be commonly used. The server-side module 820 may inherit a class of the basic common object module 810, such as object “Dealer” having inherited object “RoomPlayer”.

Likewise, a client-side module 830 may also inherit a class of the basic common object module 810, such as object “Betting” having inherited object “BetMoney” or object “GamePlayer” having inherited object “RoomPlayer”.

That is, by providing a common portion through the basic common object module 810 and by using a desired object through inheritance, the server program developer and the client program developer may not need to separately configure the common portion.

According to exemplary embodiments, since a client program developer may develop a program code closely related to a service, such as a server-side service logic, among server-side program codes, a server may provide a service through modularized server-side program codes. Server-side program codes may be specialized through modularization of the server-side program codes, to reduce complexity of a program code, and to facilitate a module replacement. Servers that provide different services may share a server-side module, which may reduce or minimize the number of server developers. Also, a service developer may better concentrate on developing service contents since communication time with server-side developers and cost may decrease.

The units described herein may be implemented using hardware components, software components, or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The exemplary embodiments may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present disclosure, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments.

While certain example embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. A module processing method of a server configured to provide a service in a server-client environment, the method comprising:
receiving, storing, and managing, at the server, a first server module file corresponding to a server program;
receiving, storing, and managing, at the server, a second server module file corresponding to a client program;
executing, at the server, a server operation for the service using a program code comprised in the first server module file; and
processing, at the server, a service logic corresponding to the service provided to a client using a program code comprised in the second server module file,
wherein the client accesses the server using a client program.

2. The method of claim 1, wherein the first server module file comprises a module configured to manage a connection to a database for the service and a module configured to manage the access of the client, and
the second server module file comprises a module configured to control the server to process the service logic corresponding to the service to be provided to the client by the server.

3. The method of claim 1, wherein the service comprises a game service, and
the service logic is a logic for controlling a game provided through the game service to the client based on a rule of the game, and the game is controlled at the server based on the program code comprised in the second server module file.

4. The method of claim 1, wherein a basic common object module created using an objective-oriented programming language for the service is provided to develop each of the first server module file and the second server module file, and
each of the first server module file and the second server module file comprises a program code developed based on an object inheritance corresponding to the basic common object module.

5. The method of claim 1, wherein the client comprises an electronic device on which the client program is installed and executed, and
the client accesses the server over a network under control of the client program.

6. The method of claim 1, further comprising:
correcting, at the server, at least one of the program code comprised in the first server module file and the program code comprised in the second server module file to eliminate difference between programming languages used to create the program code comprised in the first server module file and the program code comprised in the second server module file.

7. A non-transitory computer-readable recording medium storing a program to implement the method of claim 1.

8. A module processing system of a server configured to provide a service in a server-client environment, the module processing system comprising:
at least one processor configured to execute non-transitory computer-readable instructions,
wherein the at least one processor comprises:
a file management controller configured to control the server to receive, store, and manage a first server module file corresponding to a server program, and to control the server to receive, store, and manage and a second server module file corresponding to a client program; and
a logic processor configured to execute a server operation for the service using a program code comprised in the first server module file, and to process a service logic corresponding to the service to be provided to a client using a program code comprised in the second server module file,
wherein the client accesses the server using a client program.

9. The module processing system of claim 8, wherein the first server module file comprises a module configured to manage a connection to a database for the service and a module configured to manage the access of the client, and
the second server module file comprises a module configured to control the server to process the service logic corresponding to the service to be provided to the client by the server.

10. The module processing system of claim 8, wherein the service comprises a game service, and
the service logic is a logic for controlling a game provided through the game service to the client based on a rule of the game, and the game is controlled at the server based on the program code comprised in the second server module file.

11. The module processing system of claim 8, wherein a basic common object module created using an objective-oriented programming language corresponding to the service is provided to develop each of the first server module file and the second server module file, and
each of the first server module file and the second server module file comprises a program code developed based on an object inheritance corresponding to the basic common object module.

12. The module processing system of claim 8, wherein the client comprises an electronic device on which the client program is installed and executed, and accesses the server over a network under control of the client program.

13. The module processing system of claim 8, wherein the at least one processor further comprises:
a code corrector configured to correct at least one of the program code comprised in the first server module file and the program code comprised in the second server module file to eliminate difference between programming languages used to create the program code comprised in the first server module file and the program code comprised in the second server module file.
